(19) United States
(12) Patent Application Publication
(10) Pub. No.: US 2013/0063819 A1
(43) Pub. Date: Mar. 14, 2013

(54) Methods and apparatus for polarizing laser light

(71) Applicant: Donald K. Wilson, West Caldwell, NJ (US)

(72) Inventor: Donald K. Wilson, West Caldwell, NJ (US)

(21) Appl. No.: 13/199,972

(22) Filed: Sep. 13, 2011

(51) Int. Cl. G02B 5/30

(52) U.S. Cl. 359/489.09

(57) ABSTRACT

Methods and apparatus for polarizing un-polarized laser light by passing a beam of un-polarized laser light through an isotropic, right-angle prism having a dielectric coating on its hypotenuse incident upon the coated hypotenuse at an angle of incidence less than the critical angle wherein the net-refractive index of the coating and angle of incidence on the hypotenuse are mutually selected to achieve maximum separation of the S and P constituents of the beam with a maximum percent of the S-constituent internally reflected and a maximum percent of the P-constituent transmitted through the coated hypotenuse.

### TECHNICAL FIELD

This invention relates to methods for polarizing laser light and laser polarizers for the performance of the said methods which are relatively inexpensive, and significantly less expensive than existing—Laser Polarizers such as the Glan Polarizer.

The method includes passing laser light through at least one right angle prism made of isotropic material having a dielectric coating on its hypotenuse. The light is passed through one of the faces of the prism including the right angle so as to be incident on the hypotenuse at an angle which, together with the coating effects a desired separation of the S-polarized component from the P-polarized component whereby a minimum if the S-component emerges from the coated hypotenuse and a maximum of the P-component emerges therefrom.

The method also preferably includes a second right angle prism having the same characteristics whereby the P-polarized component emerging from the first prism passes through an air gap and into a preferably coated hypotenuse of the second prism emerging through one of its other faces generally parallel to the laser light incident upon the first prism.

While the present invention is particularly well-suited for use with laser light, it may be employed with non-laser light depending although there is little commercial interest in such an application.

### BACKGROUND OF INVENTION

### Terms and Concepts

As used herein, isotropic materials should be given its ordinary meaning in the art of light transmitting materials that have the same properties in all directions. This means light passes through them in the same way, with the same velocity, no matter what direction the light is traveling. Anisotropic materials as used herein means materials that have different properties in different directions. So, light travels through them in different ways and with different velocities, depending on the direction of travel through the medium.

Total internal reflection as used herein is to be given its ordinary meaning in the art and is an optical phenomenon that occurs when a ray of light strikes a medium boundary at an angle larger than a particular critical angle with respect to the normal to the surface. If the refractive index is lower on the other side of the boundary, no light can pass through and all of the light is reflected. The critical angle is the angle of incidence above which the total internal reflection occurs.

When light crosses a boundary between materials with different refractive indices, the light beam will be partially refracted at the boundary surface and partially reflected. The critical angle as used herein is to be given its ordinarily meaning the art and is that angle of incidence at which light is refracted such that it will not cross the boundary altogether but rather be totally internally reflected back. This occurs only when light travels from a medium with a higher refractive index [n1] to one with a lower refractive index [n2]; for example, when passing from glass into air, but not when passing from air into glass.

The state of polarization (SOP) as used herein of a light ray is to be given its ordinary meaning in the art meaning, that is, light incident upon a reflecting/transmitting surface at any non-perpendicular angle will be altered as compared to the incident light. The S (perpendicular) and P (parallel) components of the reflected/transmitted light are described by Fresnel Coefficients.

### Prior Art

The Glan laser polarizer is an industry standard laser polarizer. Its design is based on the natural separation between the oppositely polarized ordinary and extraordinary rays that occur during transmission through the birefringent prisms of the Glan polarizer. Two, identical, right-angle prisms made from calcite crystal, a naturally occurring birefringent crystal, are employed with an air-gap between opposed hypotenuses faces of the respective prisms. The extraordinary (P-polarized) ray is transmitted through both prisms while the ordinary ray (S-polarized) is reflected off the hypotenuse and transmitted out an escape window≈(typically 23° exit angle for a normal incidence beam) allowing the component to be used as a polarizing beam splitter. The extraordinary ray is the same as the P-polarized ray and the ordinary ray is the same as the S-polarized ray.

### SUMMARY OF INVENTION

The method includes passing laser light, preferably normally, through one of the faces of a right angle prism forming the right angle of that prism made of an isotropic material, such as fused silica or glass such as BK 7 glass wherein the angle of incidence of the laser light passing through that prism and incident upon the hypotenuse is less than the critical angle. then passing the light through a dielectric coating on the hypotenuse of the prism capable of effecting a desired separation of the S-polarized (hereafter simply S) constituent of the laser light from the P-polarized constituent (hereafter simply P) whereby a minimum of the S-constituent and a maximum of the P-constituent emerges from the coated hypotenuse, the included angle between the first face of the prism and the hypotenuse being a function of the effective refractive index of the dielectric coating.

The method preferably further including passing the P-constituent of the light emerging from the said coating on the hypotenuse of the first prism across an air-gap and from thence through the hypotenuse of a second isotropic prism to and through one of the faces including the right angle of that second prism, the hypotenuse of the second prism preferably being provided with a dielectric coating such that the light emerging from a right angle face of that prism is substantially parallel to the light incident upon the first face of the first prism.

The invention herein includes apparatus for performing said methods including at least one isotropic right angle prism having a dielectric coating on its hypotenuse, the angle between the hypotenuse and the right angle faces of the prism being a function of the net-effective refractive index of the coating such as to maximize the amount of the S-component of the light internally reflected at the hypotenuse and maximize the amount of the P-component transmitted through said prism and coating. Preferably, the present invention may employ first and second isotropic, right-angle prisms, with their respective hypotenuses being parallel and spaced apart to define an air-gap, the first said prism having one right angled face for receiving incident light and a dielectric coating on its hypotenuse capable of effecting a desired separation between the S and P components of light incident on the first said prism and preferably a dielectric coating on the hypotenuse of the second prism capable of receiving the said P-component and transmitting it through one of the right-angle faces of the second prism.

### DETAILED DESCRIPTION OF INVENTION

An embodiment of the invention is shown schematically in the attached drawings in which:

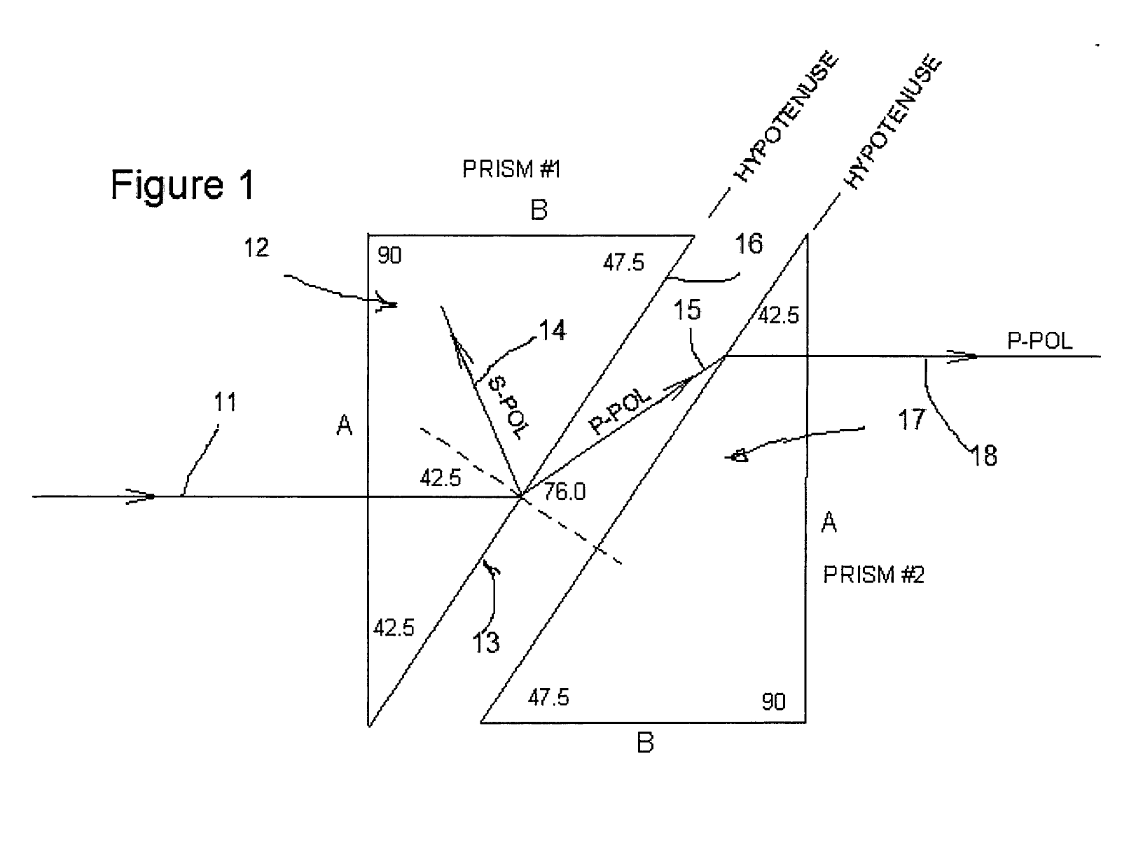

FIG. 1 is a schematic, side elevation view of a pair of right angle isotropic prisms made of fused silica with their respective hypotenuses in parallel opposition to each other defining an air gap there between and a beam of un-polarized laser light passing therethough and showing a beam of un-polarized laser light incident upon Face A of the first prism, passing through the first prism to its hypotenuse, through a dielectric coating on the hypotenuse whereby the S-constituent is substantially internally reflected and the P-component emerges from the coated hypotenuse, passing through the air gap and into the preferably-coated hypotenuse of a second isotropic right angle prism passing therethrough and out of a face of that prism generally parallel to the laser light incident upon the first prism thereby separating the S- and P-constituents.

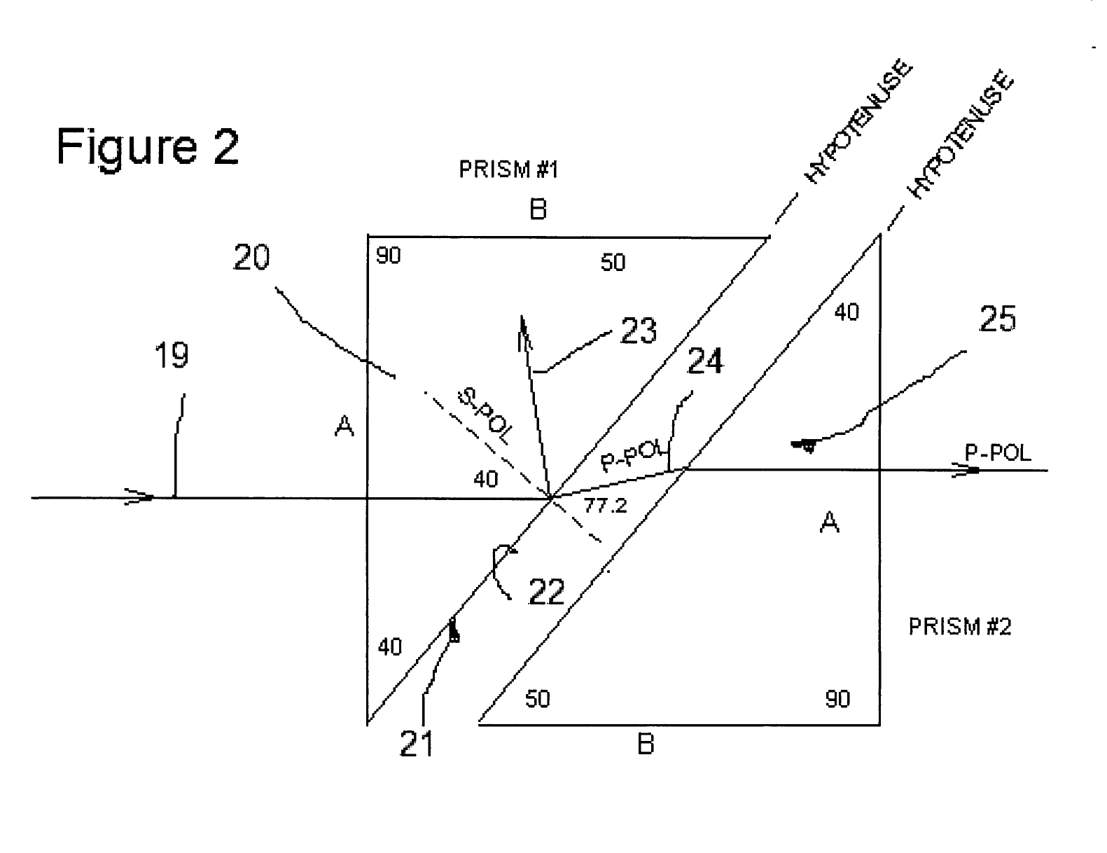

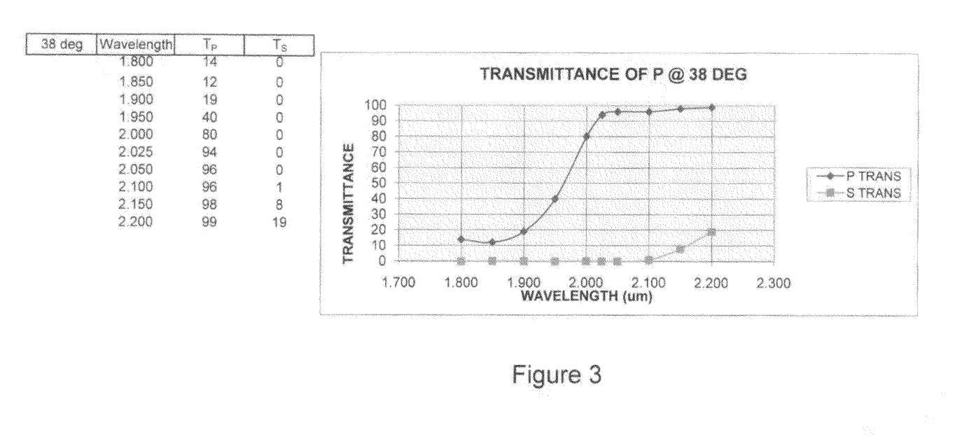

FIG. 2 is a schematic, side elevation view of a pair of right angle isotropic prisms as shown in FIG. 1 with their respective hypotenuses in parallel opposition to each other defining an air gap there between and showing a beam of un-polarized laser light incident upon Face A of the first prism, passing through the first prism to its hypotenuse, through a dielectric coating on the hypotenuse whereby the S-constituent is substantially internally reflected and the P-component emerges from the coated hypotenuse, through the air gap and into the preferably coated hypotenuse of a second isotropic right angle prism passing therethrough and out of a face of that prism generally parallel to the laser light incident upon the first prism. FIG. 2 is illustrative of prisms fabricated of glass such as BK 7 and relates generally to the graphs shown in FIGS. 3, 4 and 5;

FIG. 3 is a graph with a table of points plotted in the graph of transmittance of the S and P constituents of un-polarized laser light at different wave lengths from 1.800 um to 2.200 um passing through the first prism of FIG. 1 with the angle of incidence of the beam at the hypotenuse of the first prism being 40 degrees;

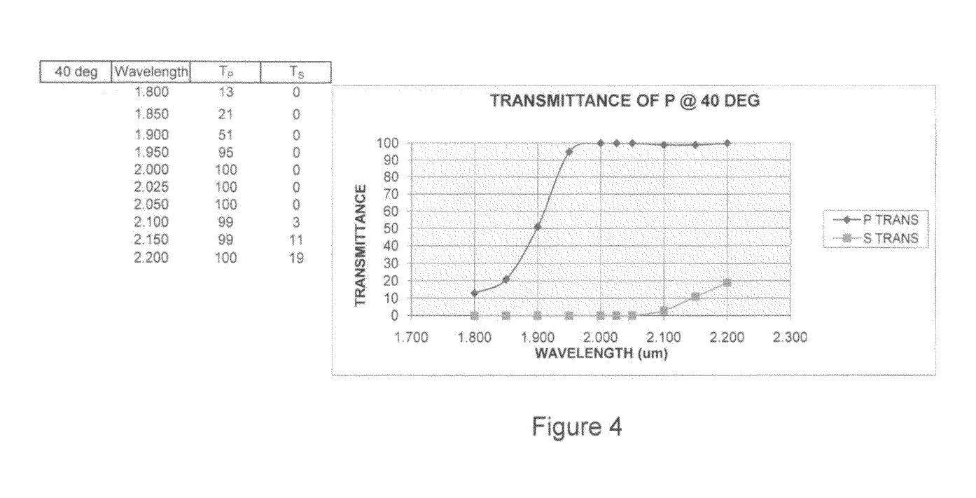

FIG. 4, is a graph with a table of points plotted in the graph of transmittance of the S and P constituents of un-polarized light at wave lengths from 1.800 um to 2.200 um as in FIG. 3 wherein the angle of incidence of the beam at the hypotenuse of the first prism being 38 degrees;

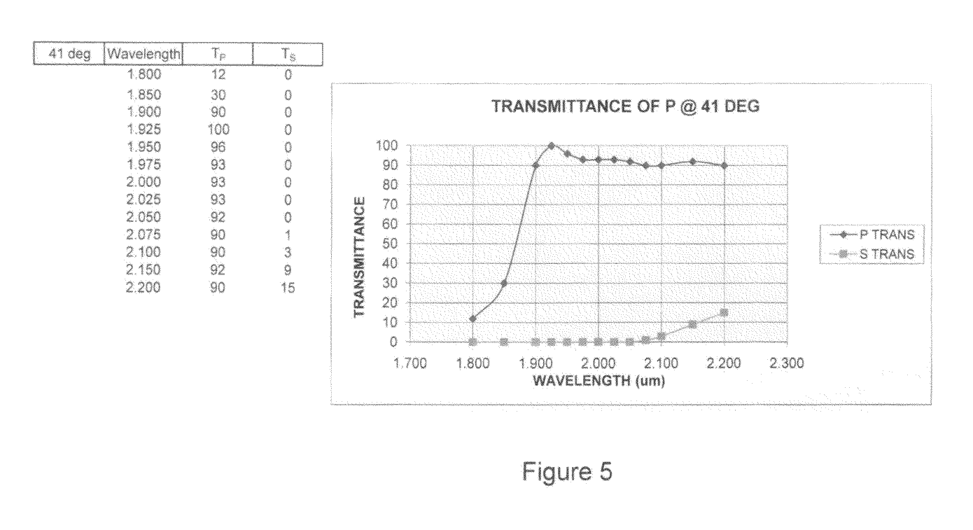

FIG. 5, is a graph with a table of points plotted in the graph of the transmittance of the S and P constituents of un-polarized light at wave lengths from 1.800 um to 2.200 um as in FIGS. 3 and 4 wherein the angle of incidence of the beam at the hypotenuse of the first prism being 41 degrees.

Referring now to the drawings in detail, FIG. 1, shows a beam 11 of un-polarized light incident on a first face, A, one of the two faces A and B including the right angle of prism 12 fabricated of an isotropic material, in this case, fused silica. The hypotenuse 13 of prism 12 extends between faces A and B. The angle of incidence of the beam 11 after passing through prism 12 upon the hypotenuse 13 is 40° as shown in FIG. 1. Because the beam 11 is not perpendicular to the hypotenuse, it becomes partially polarized but insufficiently to separate the S and P constituents so that a maximum of the S-constituent is totally internally reflected as shown in FIG. 1 as beam 14 and a maximum of the P-constituent, shown as beam 15 is passed through the hypotenuse 13 having a dielectric coating 16 applied to the hypotenuse 13. The refractive index of the dielectric coating 16 is selected to maximize the percentage of internally reflected S-constituent 14 and maximize the amount of P-constituent 15 transmitted at the hypotenuse 13. i.e. increases separation.

At this point, the maximum separation has been achieved. The S-constituent can be passed through the second face B of the first prism 12 and the P-constituent passed out of the coated hypotenuse 14 of the first prism 12.

Nevertheless, it is preferable to employ a second anisotropic prism 17 to cause the maximally separated P-constituent beam 15 to emerge from the second prism 17 substantially parallel to the beam 11 of un-polarized laser light incident upon the first prism 12.

Like the first prism 12, hypotenuse 18 of the second prism is coated with a dielectric material in the same fashion as the first prism 12. The second prism 17 has the same angles at either end of its hypotenuse 18 is parallel to the hypotenuse 13 of the first prism 12.

After passing through the second prism 17, the P-polarized component emerges as beam 18 from face A of the second of prism 17.

The object of the invention is to generate a desired separation of the S and P components of the incident, un-polarized, laser light such that a maximum of the P constituent is transmitted through the coating on the hypotenuse 13 of the first prism 12 whereas a maximum of the S-component is totally, internally reflected in the first prism 12. The second prism 17 provides the function of emitting the P-component at 18 parallel to the incident beam 11 of un-polarized light incident upon the first prism 12.

Since in FIG. 1, the incident laser light is normal to the face A of the first prism 11, the angle of the hypotenuse 13 between the two faces comprising the right angle, is, as a practical matter, a function of the net index of refraction of available coatings. The object is to balance the refractive indices of the first prism with the net refractive index of the coating so as to achieve total internal reflection of the S-component in the first prism with optimal transmission of the P-component through the coating 16 on the hypotenuse 13 of the first prism 12.

Thus, as a practical matter, the angle between face A of the first prism 12 on which light is incident and its hypotenuse, 13, is a function of net index of refraction of available coatings on its hypotenuse 13. FIG. 2 illustrates a two-prism arrangement as in FIG. 1 wherein the prisms are made of fused silica. In the case of FIG. 2, the un-polarized beam of laser light impinges normal to Face A of prism 20 passing therethrough to its hypotenuse 21. A dielectric coating 22 on the hypotenuse 21 has a net refractive index so as to maximize the total internal reflection of the S-constituent 23 and maximizing transmission of the P-constituent 24 emerging from the coated hypotenuse 21.

Referring to FIG. 2 merely as an example, the prisms, 20 and 25 of this invention may each have an index of refraction of 1.44 at 2.000 μm, each prism being 42.5°×47.5°×90°.The prisms are preferably fabricated of infra-red transmitting grade of fused silica but any isotropic material such as CaF2 can be employed.

The maximum separation of the S and P-constituents is a function of wavelength. However, as a practical matter, this is not a significant limitation because laser light falls within a narrow wavelength range as can be seen from the graphs of FIGS. 3, 4 and 5.

While the present invention is particularly useful with un-polarized incident light, it can also be used with partially polarized or polarized incident light depending on the application.

While FIGS. 1 and 2 show the use of two prisms, it is possible to implement the present invention with a single prism if the location of the emerging P-constituent is not critical. The second prisms as shown in FIGS. 1 and 2 function to redirect the P component so as to be parallel with the input incident beams as—they emerge from the respective face A of the prisms 17 and 25.

Additionally, while the preferred embodiment uses coatings on both hypotenuses of the two-prism system, only the first need be coated because a coating on the second prism's hypotenuse does not significantly increase the separation of the S and P constituents.

The separation of the S and P-constituents is in part of function of the wave length to the incident laser beam. As is evident from FIGS. 3, 4 and 5, the graph's shift to one side or the other with variations in wave length. The methods and apparatus disclosed herein may be tuned to adjust for wave-length variations by altering the angle of incidence of the beam on the first prism to maximize separation for a particular wave length.

The dielectric coatings employed in this invention are well-known in the art. Dielectric coatings, also called thin-film coatings or interference coatings, consist of thin (typically sub-micron) layers of transparent dielectric materials, which are deposited on a substrate frequently by vacuum deposition or electron beam deposition. Their function is essentially to modify the reflective properties of the surface by exploiting the interference of reflections from multiple optical interfaces of the layers comprising the total coating. They can be used for highly reflecting laser mirrors or partially transmissive output couplers, for dichroic mirrors (treating different wavelengths differently), for anti-reflection coatings, for various kinds of optical filters (e.g. for attenuation of certain wavelength regions), beam splitters, heat reflectors, solar cell covers, and thin-film polarizers. Normally, dozens of thin-film layers are employed, sometimes even more than 100.

In many cases, the coating substrate is some kind of glass, with a wide transparency range and high optical quality (low bubble content), a very smooth surface and high durability.

Electron beam deposition involves the evaporation of material in a crucible by heating with an electron beam, which is generated from a hot filament and focused with a magnetic field. In the vacuum chamber, the evaporated material moves to the substrate, which can be covered with a mechanical shutter as soon as the right amount of material has been deposited. The target substrate is sometimes heated to improve the quality hardness of the dielectric layers.

A similar method uses evaporation by resistive heating of the crucible. Ion-assisted deposition essentially works like the electron beam evaporation but involves an additional ion beam which hits the target substrate. The comparatively high energy of the deposited material, can lead to denser coatings even without heating the substrate.

Ion beam sputtering uses an ion beam which, after neutralization with a second filament, hits a metal or metal oxide target to sputter material to the substrate. It generates a fairly uniform, non-porous coating with good adhesion and very low surface roughness and is well reproducible but relatively slow and expensive.

In any one of the above cases, one starts with some homogeneous substrate material such as BK7 glass, fused silica, or CaF2. Common coating materials are oxides such as SiO2, TiO2 and fluorides such as MgF2 and LaF2. The layers obtained are usually amorphous, with a density which can (depending on the fabrication technique) deviate from that of bulk material by more than 10%. Electron beam deposition typically generates materials with lower densities, and thus also a lower refractive index. Humidity can affect the refractive index. Ion-assisted deposition and particularly ion beam sputtering achieve a higher density and accordingly a low dependence on humidity. The optical damage threshold can also depend on the fabrication method.

It is not the purpose of the above description of typical coatings and their application to be exhaustive. For the purposes of this invention, it is the net refractive index of the coating which is most important. Those skilled in the art of dielectric coatings and their application to the substrates appropriate for this invention can produce suitable coatings. One such coater is Thin Film Lab Optical Coatings of Milford, Pa.

What is claimed:

1. A method for polarizing laser light comprising,
a. impinging a beam of un-polarized laser light on one face of including the right angle of a right-angled prism made of an isotropic material the said beam defining an S-constituent and a P-constituent,
b. impinging the beam passing through the prism to its onto the hypotenuse of the prism having a dielectric coating capable of effecting separation of the S and P constituents of the beam,
c. selecting a net-refractive index of the coating whereby a desired percent of the S-constituent is totally internally reflected and a desired percent of the P-component is transmitted though the coated hypotenuse.

2. The method in accordance with claim 1,
a. selecting an angle of incidence of the beam passing through the prism on the coated hypotenuse and a net-refractive index of the coating on the hypotenuse whereby at any given wavelength of the laser beam incident on the prism a desired percent of the S-constituent is totally internally reflected at the hypotenuse and a desired percent of the P-constituent is transmitted through the coated hypotenuse.

3. The method in accordance with claim 1 in which,
(a) The said beam entering the said face of the prism is normal to the plane of that face.

3. The method in accordance with claim 1, and
(a) adjusting the angle of incidence of the beam of un-polarized laser light on the prism to accommodate for variations in the wavelength of the un-polarized laser light to achieve a desired end result separation of the S and P components.

4. The method in accordance with claim 1 and,
(a) passing the light emerging from the coated hypotenuse of the first said prism through an air-gap and onto the hypotenuse of a second, right angle prism made of a isotropic material,
b. the hypotenuse of the second prism being parallel to the hypotenuse of the first said prism,
c. passing the separated P-component through the second said prism to emerge from one of the faces including the right angle, substantially parallel to the beam incident on the first said prism.

5. The method in accordance with claim 4 in which,
a. the hypotenuse of the second prism having a dielectric coating.

6. A laser polarizer comprising,
b. a right-angled prism made of isotropic material defining a hypotenuse and two included angles between the faces making up the right angle and the hypotenuse,
c. means for impinging a beam of un-polarized, laser light defining an S-constituent and a P-constituent on one of the faces of the prism including the right-angle(c) a dielectric coating on the hypotenuse of the prism,
d. the net refractive index of said coating being selected such that a desired percent of the S-constituent is totally internally reflected and a desired percent of the P-constituent is transmitted from the coating on the hypotenuse.

7. A laser polarizer in accordance with claim 5, and
a. a second right-angle prism made of isotropic material defining a hypotenuse and two included angles between the faces making up the right angle and the hypotenuse in interrupting relationship to P-constituent light emerging from the hypotenuse of the first prism,
b. an air-gap between the hypotenuse of the first prism and the hypotenuse of the second prism,
c. the hypotenuse of the second prism being substantially parallel to the hypotenuse of the first prism, and
f. the net refractive indices of the second prism and its position with respect to the position of the first prism being selected so that the P-constituent emerges from the second prism substantially parallel to the beam incident on the first said prism.

8. A laser polarizer in accordance with claim 7 and,
a. means for adjusting the angle of incidence of the said beam on the first prism to increase the separation of the S and P constituent thereof emerging therefrom for any given wave-length range.
